(19) United States
(12) Patent Application Publication
(10) Pub. No.: US 2013/0339624 A1
(43) Pub. Date: Dec. 19, 2013

(54) PROCESSOR, INFORMATION PROCESSING DEVICE, AND CONTROL METHOD FOR PROCESSOR

(71) Applicant: FUJITSU LIMITED, Kawasaki (JP)

(72) Inventor: Go SUGIZAKI, Machida (JP)

(73) Assignee: FUJITSU LIMITED, Kawasaki (JP)

(21) Appl. No.: 13/970,934

(22) Filed: Aug. 20, 2013

Related U.S. Application Data
(63) Continuation of application No. PCT/JP2011/056849, filed on Mar. 22, 2011.

(51) Int. Cl. G06F 12/12

(52) U.S. Cl. CPC G06F 12/122
USPC 711/136

(57) ABSTRACT

A processor is connected to a main storage device and includes a cache memory unit, a tag memory unit, a main storage control unit, a cache control unit, a main storage access monitoring unit, a cache access monitoring unit, and a swap control unit. The cache memory unit includes a plurality of cache lines. The tag memory unit includes a plurality of tags. The main storage control unit accesses the main storage device. The cache control unit accesses the cache memory unit. The main storage access monitoring unit monitors a first access frequency. The cache access monitoring unit monitors a second access frequency. The swap control unit allows the cache control unit to retain data in the main storage device based on the first access frequency, the second access frequency, and state information retained in a tag.

### CROSS-REFERENCE TO RELATED APPLICATION

This application is a continuation of International Application No. PCT/JP2011/056849, filed on Mar. 22, 2011 and designating the U.S., the entire contents of which are incorporated herein by reference.

### FIELD

The embodiments discussed herein are directed to a processor, an information processing device, and a control method for the processor.

### BACKGROUND

There is a related arithmetic processing unit that includes a memory controller and a cache memory. A known example of such an arithmetic processing unit is a central processing unit (CPU) that executes a swap process that replaces already-cached data with new data when the new data is cached in a cache memory that is in the CPU itself.

FIG. 16 is a schematic diagram illustrating a related CPU. In the example illustrated in FIG. 16, a CPU 60 includes an instruction execution unit 61, an L1 (level 1) cache control unit 62, an L2 (level 2) cache control unit 65, a memory control unit 68, and an inter-LSI communication control unit 69. Furthermore, the CPU 60 is connected to a memory 70, which is the main memory, other CPUs 71 to 73, and a crossbar switch (XB) 74.

The L1 cache control unit 62 includes an L1 tag storing unit 63 that stores therein, for each cache entry, tag data indicating the state of the cache data and also includes an L1 data storing unit 64 that stores therein, for each cache entry, cache data. Similarly, the L2 cache control unit 65 includes an L2 tag storing unit 66 that stores therein, for each cache entry, tag data indicating the state of the cache data and also includes an L2 data storing unit 67 that stores therein, for each cache entry, cache data.

In addition to data stored in the memory 70 functioning as the main storage, the CPU 60 having such a configuration as that described above acquires data from a memory connected to each of the CPUs 71 to 73 and a memory or the like connected to another CPU that is connected to the XB 74 via the inter-LSI communication control unit 69. Furthermore, if the CPU 60 receives a read request for data from one of the CPUs 71 to 73 or from the other CPU that is connected to the XB 74 via the inter-LSI communication control unit 69, the CPU 60 sends data targeted by the read request from among data cached by the CPU 60 itself.

In the following, an example case will be given in which the L2 cache control unit 65 in the CPU 60 acquires data from the memory 70. For example, if data requested from the instruction execution unit 61 is not stored in the L2 data storing unit 67, the L2 cache control unit 65 acquires, from the memory 70, data targeted by the request. Then, the L2 cache control unit 65 searches for a cache entry in which data can be newly registered.

At this point, if the L2 cache control unit 65 determines that no cache entry is present in which data can be newly registered, the L2 cache control unit 65 selects a cache entry for storing data by using an algorithm, such as a least recently used (LRU) algorithm. Then, the L2 cache control unit 65 executes a swap process that replaces the data in the selected cache entry with the acquired data. The LRU algorithm mentioned above is an algorithm that replaces a cache entry that is not accessed for the longest time period.

In the following, the flow of the swap process performed by the L2 cache control unit 65 will be described. FIG. 17 is a schematic diagram illustrating the status of the data in the cache entries. In the example illustrated in FIG. 17, the stored tag data is one of “Modified”, “Exclusive”, “Shared”, “Invalid” as used in the MESI protocol (Illinois protocol). This information indicates the state of the cache data in a cache entry.

The “Invalid” mentioned here indicates that data in a given cache entry is invalid. Consequently, if “Invalid” is included in tag data in a selected cache entry, the L2 cache control unit 65 allows the L2 data storing unit 67 to store therein data acquired from the memory 70 as data in the selected cache entry.

The “Shared” mentioned here indicates that data in a cache entry is shared by the CPU 60 and another CPU and has the same value as data in a memory that is the cache source. The “Exclusive” mentioned here indicates that data is cache data that is used only in the CPU 60 and has the same value as data in a memory that is the cache source.

Accordingly, if the selected tag data in the selected cache entry indicates “Shared” or “Exclusive”, the L2 cache control unit 65 discards the cache data registered in the selected cache entry. Then, the L2 cache control unit 65 allows the L2 data storing unit 67 to store therein data acquired from the memory 70 as data in the selected cache entry.

The “Modified” mentioned here indicates data that is used only in the CPU 60 and indicates that the data is not the same as the data in the main memory because the CPU 60 has updated the data in the CPU 60. Accordingly, if “Modified” is included in tag data in a selected cache entry, the L2 cache control unit 65, in order to retain the coherency, executes a write back process that writes data that has been registered in a cache entry in the memory 70. Then, the L2 cache control unit 65 allows the L2 data storing unit 67 to store the data acquired from the memory 70 as data in the selected cache entry.

FIG. 18 is a schematic diagram illustrating the flow of a swap process that does not perform a write back process. In the example illustrated in FIG. 18, the L2 cache control unit 65 searches the L2 data storing unit 67 for data targeted by a read request. If the requested data is not stored in the L2 data storing unit 67, the L2 cache control unit 65 issues only a read request to the memory control unit 68. In such a case, the memory control unit 68 acquires, from the memory 70, data targeted by the read request and sends the acquired data to the L2 cache control unit 65 as a response.

FIG. 19 is a schematic diagram illustrating the flow of a swap process that performs the write back process. In the example illustrated in FIG. 19, if requested data is not stored in the L2 data storing unit 67, the L2 cache control unit 65 issues, as a write back process together with a read request for the requested data, a write request indicating that cache data is to be written in a memory. In such a case, the memory control unit 68 acquires data targeted by the read request from the memory 70 and sends the acquired data to the L2 cache control unit 65 as a response. Then, the L2 cache control unit 65 executes a process for writing data targeted by the write request in the memory 70.
Patent Document 1: Japanese Laid-open Patent Publication No. 06-309231
Patent Document 2: Japanese Laid-open Patent Publication No. 59-087684

However, with the technology that executes the swap process described above, a swap process is executed if it is determined that no cache entry in which cache data is newly registered is present. Accordingly, if a swap process that executes the write back process continuously occurs, a combination of a read request and a write request is continuously issued; therefore, the busy rate of a memory bus that connects a main memory and a CPU to a memory increases. Consequently, with the technology that executes the swap process described above, there is a problem in that it is not possible to efficiently access data.

FIG. 20 is a schematic diagram illustrating a process performed when a swap process that does not perform the write back process occurs continuously. In the example illustrated in FIG. 20, if a swap process that does not perform the write back process does occur continuously, the L2 cache control unit 65 sequentially issues multiple read requests RD1 to RD 3 to the memory control unit 68. Consequently, the memory control unit 68 sequentially acquires, from the memory 70, data targeted by each of the read requests RD1 to RD3 and sends the acquired data to the L2 cache control unit 65 as a response.

In contrast, FIG. 21 is a schematic diagram illustrating a process performed when a swap process that does perform the write back process occurs continuously. As illustrated in FIG. 21, if a swap process that performs the write back process occurs continuously, the L2 cache control unit 65 alternately issues the read requests RD1 to RD3 and write requests WT1 to WT3 related to the write back process. Specifically, if the swap process that performs the write back process does occur continuously, the L2 cache control unit 65 continuously issues, to the memory control unit 68, a combination of the read requests and the write requests. Consequently, the memory control unit 68 alternately executes the reading and the writing of data, which delays a response to the subsequent read request and thus it is not possible to efficiently access data.

### SUMMARY

According to an aspect of the embodiments, a processor is connected to a main storage device. The processor includes a cache memory unit, a tag memory unit, a main storage control unit, a cache control unit, a main storage access monitoring unit, a cache access monitoring unit, and a swap control unit. The cache memory unit includes a plurality of cache lines each of which retains data. The tag memory unit includes a plurality of tags each of which is associated with one of the cache lines and retains state information on data retained in an associated cache line. The main storage control unit accesses the main storage device. The cache control unit accesses the cache memory unit. The main storage access monitoring unit monitors a first access frequency that indicates the frequency of access to the main storage device from the main storage control unit. The cache access monitoring unit monitors a second access frequency that indicates the frequency of access to the cache memory unit from the cache control unit. The swap control unit allows the cache control unit to retain data, which is retained in a cache line included in the cache memory unit, in the main storage device based on the first access frequency monitored by the main storage access monitoring unit, the second access frequency monitored by the cache access monitoring unit, and the state information retained in a tag.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a server according to a first embodiment;

FIG. 2 is a schematic diagram illustrating a system board according to the first embodiment;

FIG. 3 is a schematic diagram illustrating a CPU according to the first embodiment;

FIG. 4 is a schematic diagram illustrating a memory control unit according to the first embodiment;

FIG. 5 is a schematic diagram illustrating the busy rate that is sent by a memory busy rate monitoring unit to a pre-swap starting unit as a notification;

FIG. 6 is a schematic diagram illustrating an L2 cache control unit according to the first embodiment;

FIG. 7 is a schematic diagram illustrating the pre-swap starting unit;

FIG. 8 is a schematic diagram illustrating an example of the start condition for a pre-swap process;

FIG. 9 is a schematic diagram illustrating a process for searching for an entry targeted for the pre-swap process;

FIG. 10 is a schematic diagram illustrating the target for the pre-swap process;

FIG. 11 is a schematic diagram illustrating the flow of the pre-swap process;

FIG. 12 is a flowchart illustrating the process for searching for an entry targeted for a pre-swap;

FIG. 13 is a flowchart illustrating the flow of a pre-swap start condition determining process;

FIG. 14 is a flowchart illustrating, in detail, the flow of a process for searching for an entry;

FIG. 15 is a flowchart illustrating an example of the shift of the state of a cache included in each CPU that is used in an SMP system;

FIG. 16 is a schematic diagram illustrating a related CPU;

FIG. 17 is a schematic diagram illustrating the status of data in cache entries;

FIG. 18 is a schematic diagram illustrating the flow of a swap process that does not perform a write back process;

FIG. 19 is a schematic diagram illustrating the flow of a swap process that performs the write back process;

FIG. 20 is a schematic diagram illustrating a process performed when the swap process that does not perform the write back process occurs continuously; and

FIG. 21 is a schematic diagram illustrating a process performed when the swap process that performs the write back process occurs continuously.

### DESCRIPTION OF EMBODIMENTS

Preferred embodiments will be explained with reference to accompanying drawings.

### [a] First Embodiment

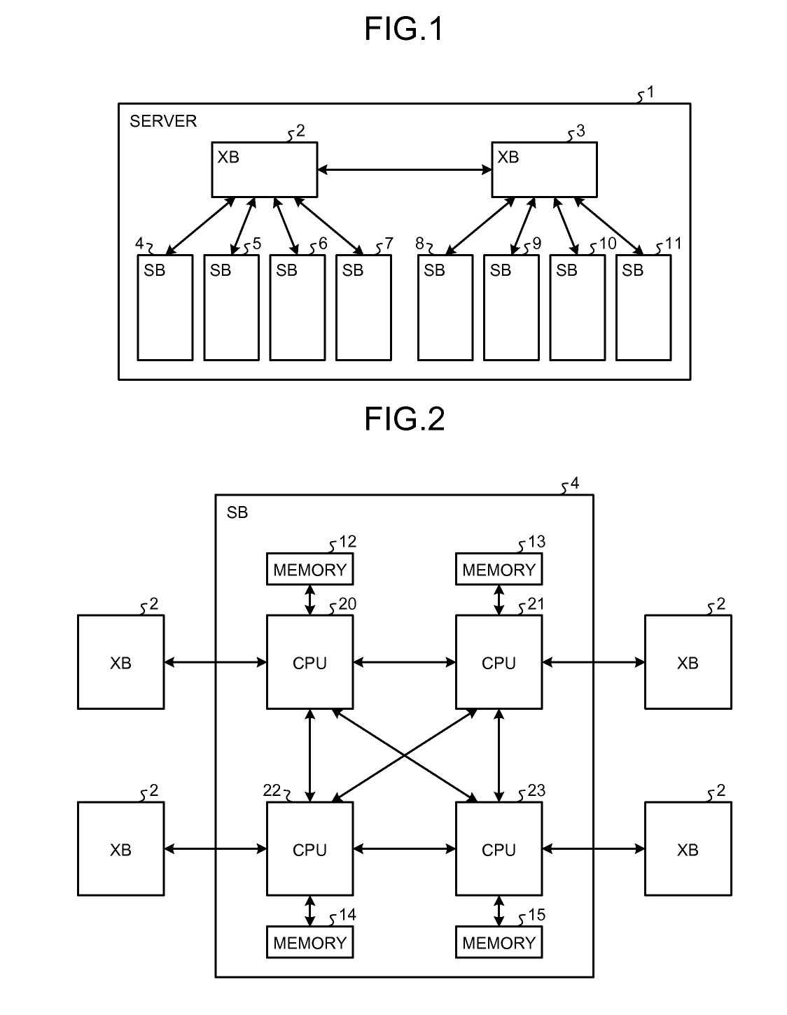

In a first embodiment, an example of a server that functions as an information processing device and that includes multiple central processing units (CPUs) functioning as arithmetic processing units will be described with reference to FIG. 1. FIG. 1 is a schematic diagram illustrating a server according to a first embodiment. As illustrated in FIG. 1, a server 1 includes a crossbar switch (hereinafter, simply referred to as XB) 2, an XB 3, and the like. Multiple system boards (hereinafter, simply referred to as SBs) 4 to 7 and the like are connected to the XB 2. SBs 8 to 11 and the like are connected to the XB 3. The number of crossbar switches and system boards illustrated in FIG. 1 is only an example and is not limited thereto.

The XB 2 and the XB 3 are switches that dynamically select a path for data exchanged between the SBs 4 to 11. The SBs 4 to 11 connected to the XB 2 or the XB 3 are processing units each of which includes CPUs and memories. The SBs 4 to 11 have the same configuration; therefore, only the SB 4 will be described in a description below.

FIG. 2 is a schematic diagram illustrating a system board according to the first embodiment. In the example illustrated in FIG. 2, the SB 4 includes memories 12 to 15 and CPUs 20 to 23. The CPUs 20 to 23 are connected with each other and are the arithmetic processing units disclosed in the embodiment. Furthermore, the CPUs 20 to 23 are connected to the memories 12 to 15, respectively. The CPUs 21 to 23 have the same configuration as that of the CPU 20; therefore, only the CPU 20 will be described in a description below.

The CPU 20 can acquire data stored in the memory 12, which is the main memory, and can acquire data stored in each of the memories 13 to 15 via the other CPUs 21 to 23. Furthermore, each of the CPUs 20 to 23 is connected to the XB 2 and can acquire data stored in the memories included in the SBs 8 to 11 connected to the XB 3 (not illustrated in FIG. 2) that is connected to the XB 2.

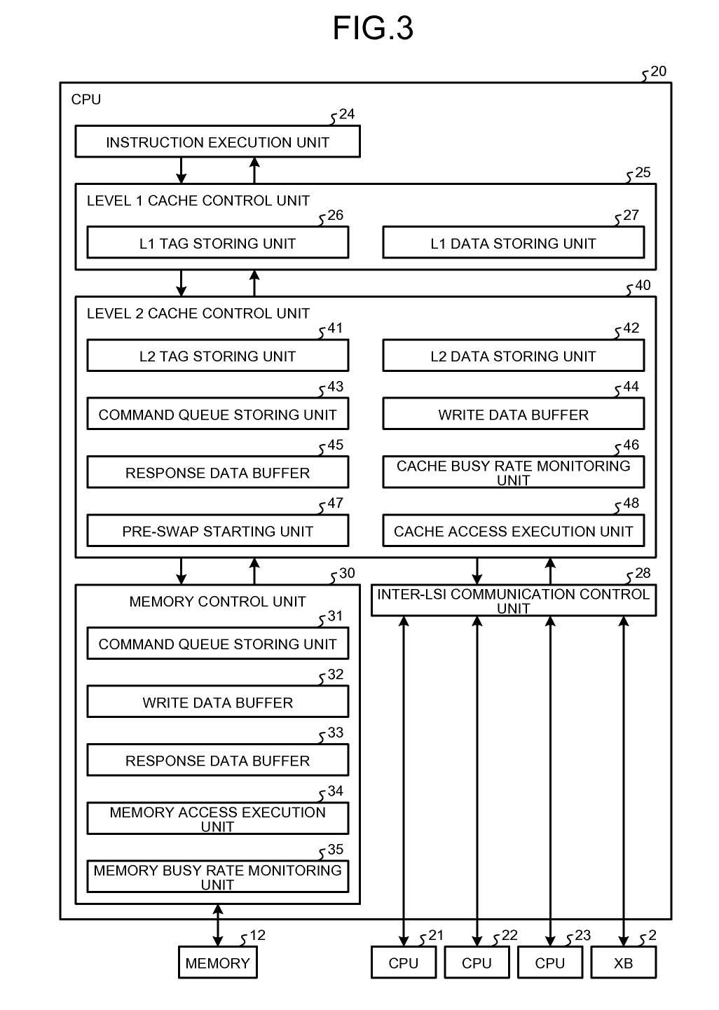

FIG. 3 is a schematic diagram illustrating a CPU according to the first embodiment. In the example illustrated in FIG. 3, the CPU 20 includes an instruction execution unit 24, an L1 (level 1) cache control unit 25, an inter-LSI communication control unit 28, a memory control unit 30, and an L2 (level 2) cache control unit 40.

The L1 cache control unit 25 includes an L1 tag storing unit 26 that stores therein tag data and also includes an L1 data storing unit 27 that stores therein cache data. The memory control unit 30 includes a command queue storing unit 31, a write data buffer 32, a response data buffer 33, a memory access execution unit 34, and a memory busy rate monitoring unit 35.

The L2 cache control unit 40 includes an L2 tag storing unit 41 that stores therein tag data and also includes an L2 data storing unit 42 that stores therein cache data. Furthermore, the L2 cache control unit 40 includes a command queue storing unit 43, a write data buffer 44, a response data buffer 45, a cache busy rate monitoring unit 46, a pre-swap starting unit 47, and a cache access execution unit 48.

In the following, a process performed by each of the units included in the CPU 20 will be described. The instruction execution unit 24 is the processor core of the CPU 20 that executes processes by using cache data included in the L1 cache control unit 25. For example, the instruction execution unit 24 sends a virtual address in the memory 12 to the L1 cache control unit 25 and acquires, from the L1 cache control unit 25, data stored in the sent virtual address.

The L1 cache control unit 25 controls an L1 cache memory that is used by the instruction execution unit 24. Specifically, the L1 cache control unit 25 includes the L1 tag storing unit 26 that retains, for each cache line, information indicating the state of cache data, includes the L1 data storing unit 27 that retains, for each cache line, cache data, and controls the L1 tag storing unit 26 and the L1 data storing unit 27. If the L1 cache control unit 25 acquires a request for data from the instruction execution unit 24, the L1 cache control unit 25 searches the L1 data storing unit 27 for cache data requested from the instruction execution unit 24.

After the searching, if the requested cache data is stored in the L1 data storing unit 27, the L1 cache control unit 25 reads the requested cache data from the L1 data storing unit 27 and then sends the requested cache data to the instruction execution unit 24. In contrast, if the requested cache data is not stored in the L1 data storing unit 27, the L1 cache control unit 25 sends, to the L2 cache control unit 40, a read command that is a request for sending the requested cache data.

The inter-LSI communication control unit 28 controls the communication between the CPU 20 and the other CPUs 21 to 23 or the communication between the CPU 20 and the XB 2. For example, the inter-LSI communication control unit 28 receives, from the CPU 21, a read request for data stored in the memory 12. In such a case, the inter-LSI communication control unit 28 requests data targeted by the read request from the L2 cache control unit 40.

At this point, the L2 cache control unit 40 that received the request for the data stored in the memory 12 from the inter-LSI communication control unit 28 acquires the data from the memory 12 and then sends the acquired data to the inter-LSI communication control unit 28. Then, the inter-LSI communication control unit 28 sends the data acquired from the L2 cache control unit 40 to the CPU 21.

In the description below, a description will be given of a process in which the CPU 20 caches data stored in the memory 12 and a description will also be given of an example in which the CPU 20 uses the cached data, received from the memory 12, as the target for the swap process.

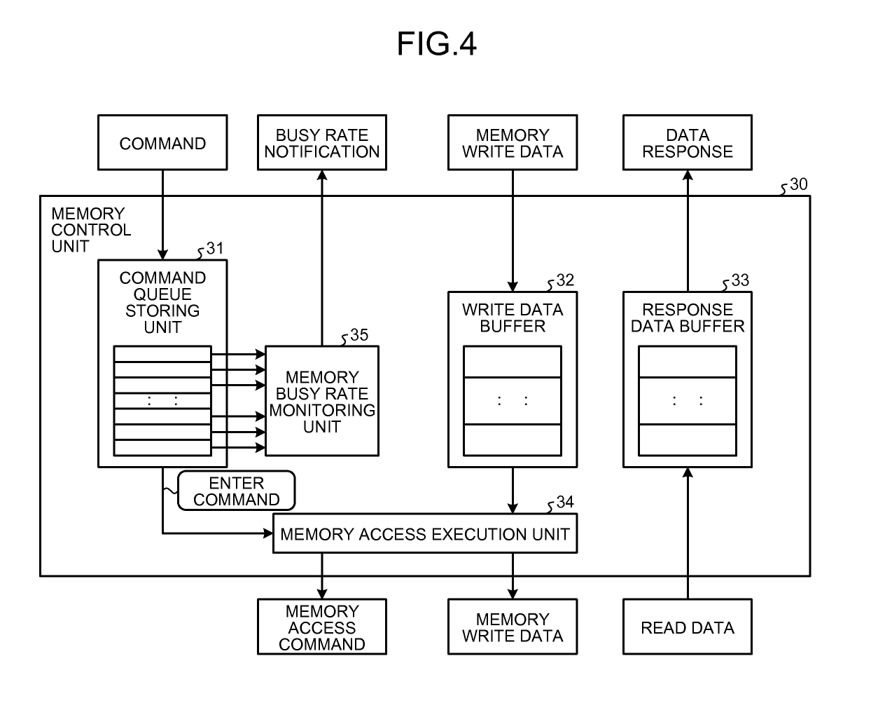

The memory control unit 30 accesses the memory 12. In the following, each of the units included in the memory control unit 30 will be described with reference to FIG. 4. FIG. 4 is a schematic diagram illustrating a memory control unit according to the first embodiment.

If the command queue storing unit 31 receives a read command, which is a request for data to be read, or a write command, which is a request for data to be written, from the cache access execution unit 48 in the L2 cache control unit 40, the command queue storing unit 31 retains the received command. Then, the command queue storing unit 31 enters each of the retained commands into the memory access execution unit 34 in the order they are received from the cache access execution unit 48.

If the write data buffer 32 receives write data targeted by a write request from the write data buffer 44 in the L2 cache control unit 40, the write data buffer 32 retains the received write data.

For example, when the cache access execution unit 48 issues a write command to the command queue storing unit 31, the write data buffer 32 immediately receives the write data from the write data buffer 44 in the L2 cache control unit 40. In such a case, the write data buffer 32 retains the received write data. Furthermore, if the write data buffer 32 receives a request for the write data from the memory access execution unit 34, the write data buffer 32 sends, to the memory access execution unit 34, the write data that was received most recently from among the pieces of retained write data.

If the response data buffer 33 receives, from the memory 12, data targeted by the read request, the response data buffer 33 retains the received read data. Then, the response data buffer 33 sequentially sends, as a data response to the read request, the retained pieces of read data from the memory 12 to the response data buffer 45 in the L2 cache control unit 40 in the order they are received.

The memory access execution unit 34 accesses the memory 12 and executes the acquiring of data from the memory 12 and the writing of data into the memory 12. Specifically, if the memory access execution unit 34 receives a command from the command queue storing unit 31, the memory access execution unit 34 determines whether the received command is a read command or a write command.

If it is determined that the received command is a read command, the memory access execution unit 34 issues, to the memory 12, a memory access command that requests data that is stored in the address indicated by the read command from among the pieces of data stored in the memory 12.

Furthermore, if it is determined that the received command is a write command, the memory access execution unit 34 retains, in the write data buffer 32 that received the command, write data associated with the received write command. Then, if the memory access execution unit 34 acquires write data from the write data buffer 32, the memory access execution unit 34 issues, to the memory 12, a memory access command that requests the writing of data in the address indicated by the write command. Furthermore, the memory access execution unit 34 sends, to the memory 12, the write data acquired from the write data buffer 32 as memory write data.

The memory busy rate monitoring unit 35 monitors the frequency of access from the memory control unit 30 to the memory 12. Specifically, the memory busy rate monitoring unit 35 counts the number of commands retained in the command queue storing unit 31. Then, the memory busy rate monitoring unit 35 monitors, based on the number of counted commands, a first access frequency to the memory 12, i.e., monitors the busy rate of the memory 12. Then, the memory busy rate monitoring unit 35 notifies the pre-swap starting unit 47 in the L2 cache control unit 40 of the monitored busy rate.

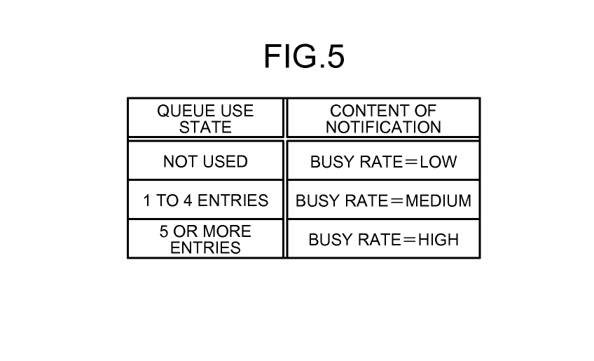

FIG. 5 is a schematic diagram illustrating the busy rate that is sent by a memory busy rate monitoring unit to a pre-swap starting unit as a notification. In the example illustrated in FIG. 5, the memory busy rate monitoring unit 35 counts the number of commands retained in the command queue storing unit 31. If the command queue storing unit 31 does not retain a command, the memory busy rate monitoring unit 35 determines that the busy rate is “low”. In such a case, the memory busy rate monitoring unit 35 notifies the pre-swap starting unit 47 that the busy rate of the memory 12 is “low”.

Furthermore, if the number of commands retained in the command queue storing unit 31 is in the range of “1 to 4” entries, the memory busy rate monitoring unit 35 determines that the busy rate of the memory 12 is “medium”. In such a case, the memory busy rate monitoring unit 35 notifies the pre-swap starting unit 47 that the busy rate of the memory 12 is “medium”.

Furthermore, if the number of commands retained in the command queue storing unit 31 is equal to or greater than “5” entries, the memory busy rate monitoring unit 35 determines that the busy rate of the memory 12 is “high”. In such a case, the memory busy rate monitoring unit 35 notifies the pre-swap starting unit 47 that the busy rate of the memory 12 is “high”. The determination reference illustrated in FIG. 5 is only an example and another setting may also be used for the number of commands that is used to determine the busy rate. For example, the number of commands counted in a predetermined time period may also be used as the busy rate of the memory 12.

As described above, the memory control unit 30 includes the memory busy rate monitoring unit 35, which monitors the busy rate of the memory 12, and notifies the pre-swap starting unit 47 in the L2 cache control unit 40 of the monitored busy rate of the memory. As will be described later, the pre-swap starting unit 47 gives priority to the execution of a write back process in accordance with the busy rate received from the memory busy rate monitoring unit 35 as a notification.

For example, if the busy rate monitored by the memory busy rate monitoring unit 35 is “low”, the pre-swap starting unit 47 gives priority to the execution of the write back process. Consequently, the CPU 20 can give priority to the execution of the write back process without degrading a data response to a normal memory access.

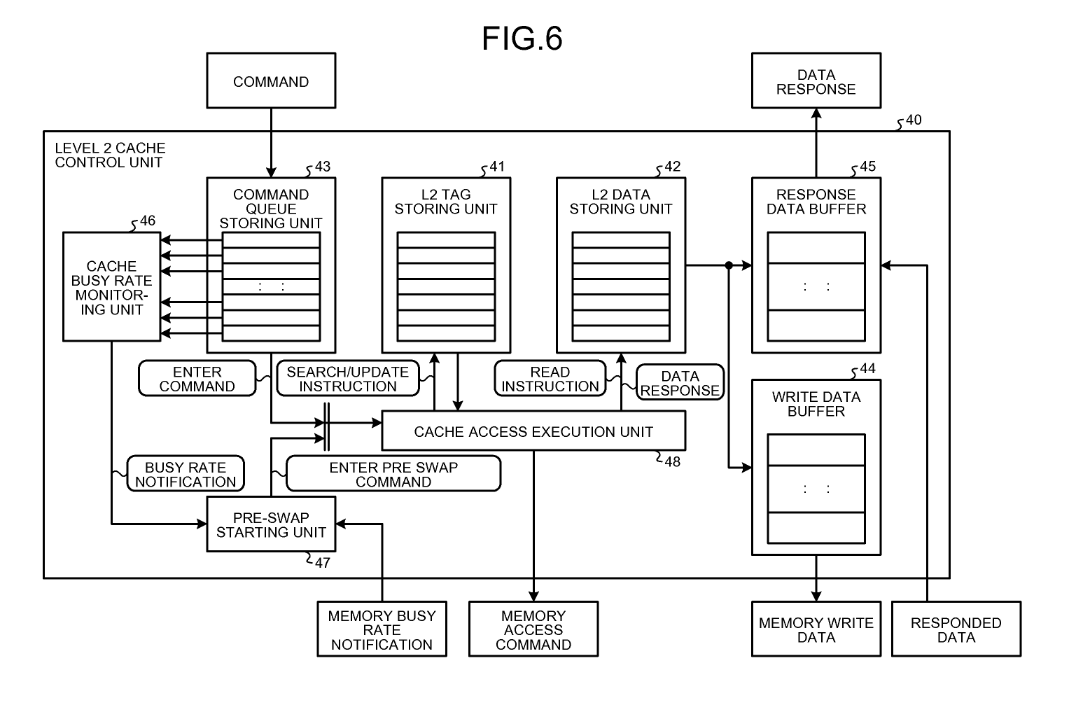

A description will be given here by referring back to FIG. 3. The L2 cache control unit 40 accesses the L2 data storing unit 42. In the following, each of the units 41 to 48 included in the L2 cache control unit 40 will be described with reference to FIG. 6. FIG. 6 is a schematic diagram illustrating an L2 cache control unit according to the first embodiment.

The L2 tag storing unit 41 includes multiple pieces of tag data and retains, for each cache line, tag data that indicates the state of each cache data that is retained, for each cache line, in the L2 data storing unit 42, which will be described later. Specifically, the L2 tag storing unit 41 retains tag data that indicates the state of each piece of cache data retained in the L2 data storing unit 42 by using one of “Invalid”, “Shared”, “Exclusive”, and “Modified”.

The L2 data storing unit 42 includes multiple cache lines and retains, for each cache line, cache data. Furthermore, if the L2 data storing unit 42 receives a read instruction from the cache access execution unit 48, the L2 data storing unit 42 acquires the data that is received by the response data buffer 45, which will be described later, from the memory control unit 30 as response data, i.e., acquires the data that is newly read from the memory 12. Then, the L2 data storing unit 42 retains the acquired data as new cache data in a cache line address that is associated with the address indicated by the received read instruction.

Furthermore, if the L2 data storing unit 42 acquires an instruction of a data response with respect to the L1 cache control unit 25 from the cache access execution unit 48, the L2 data storing unit 42 sends, to the response data buffer 45, the cache data stored in the cache line address indicated by the instruction of data response. Furthermore, if the L2 data storing unit 42 acquires a write instruction from the cache access execution unit 48, the L2 data storing unit 42 sends, to the write data buffer 44, the cache data stored in the cache line address indicated by the acquired write instruction.

If the command queue storing unit 43 receives a read command from the L1 cache control unit 25, the command queue storing unit 43 retains the received read command. Then, the command queue storing unit 43 enters the retained read command into the cache access execution unit 48 in the order the commands are received from the L1 cache control unit 25.

If the write data buffer 44 receives cache data from the L2 data storing unit 42, i.e., receives memory write data to be written in the memory 12, the write data buffer 44 retains the received memory write data. Then, the write data buffer 44 sends the received memory write data to the write data buffer 32 in the memory control unit 30.

If the response data buffer 45 receives response data from the response data buffer 33 in the memory control unit 30, i.e., receives data that is newly read from the memory 12, the response data buffer 45 retains the received data. Furthermore, if the response data buffer 45 receives cache data from the L2 data storing unit 42, i.e., receives data cached in the L2 data storing unit 42, the response data buffer 45 retains the received data. Then, the response data buffer 45 sends the pieces of retained data to the L1 cache control unit 25 in the order the pieces of retained data are received from the response data buffer 33 or the L2 data storing unit 42.

The cache busy rate monitoring unit 46 monitors the frequency of access from the cache access execution unit 48 to the L2 data storing unit 42. Specifically, the cache busy rate monitoring unit 46 counts the number of commands retained in the command queue storing unit 43. Then, the cache busy rate monitoring unit 46 monitors, based on the number of counted commands, the frequency of access to the L2 data storing unit 42, i.e., monitors the busy rate of the L2 data storing unit 42. Thereafter, the cache busy rate monitoring unit 46 notifies the pre-swap starting unit 47 of the monitored busy rate.

At this point, the number of commands retained in the command queue storing unit 43 is the number of times the cache access execution unit 48 will access the L2 data storing unit 42 in the future. Specifically, the busy rate monitored by the cache busy rate monitoring unit 46 is the busy rate of the L2 data storing unit 42.

Furthermore, as will be described later, if cache data indicated by a command is not stored in the L2 data storing unit 42, the cache access execution unit 48 issues, to the memory control unit 30, a memory access command that is a request for data to be read in the memory 12. Consequently, by counting the number of commands retained in the command queue storing unit 43, the cache busy rate monitoring unit 46 estimates the busy rate of the memory 12 that will occur in the future.

As will be described later, the pre-swap starting unit 47 acquires the memory busy rate received, as a notification, from the memory busy rate monitoring unit 35 in the memory control unit 30 and acquires the cache busy rate received, as a notification, from the cache busy rate monitoring unit 46 in the L2 cache control unit 40. Then, in accordance with the acquired memory busy rate and the cache busy rate, the pre-swap starting unit 47 determines the time at which a swap process is executed.

Consequently, the pre-swap starting unit 47 can give priority to the execution of the swap process at the time at which the current memory busy rate is lower than a predetermined rate and the estimated future memory busy rate is lower than a predetermined rate.

For example, similarly to the memory busy rate monitoring unit 35, if the command queue storing unit 43 does not retain a command, the cache busy rate monitoring unit 46 determines that the cache busy rate is “low”. Furthermore, if the number of commands retained in the command queue storing unit 43 is in the range of “1 to 4”, the cache busy rate monitoring unit 46 determines that the cache busy rate is “medium”.

Furthermore, for example, if the number of commands retained in the command queue storing unit 43 is equal to or greater than “5”, the cache busy rate monitoring unit 46 determines that the cache busy rate is “high”. Then, the cache busy rate monitoring unit 46 notifies the pre-swap starting unit 47 of the determined cache busy rate.

The pre-swap starting unit 47 acquires both the memory busy rate monitored by the memory busy rate monitoring unit 35 and the cache busy rate monitored by the cache busy rate monitoring unit 46. Then, based on the acquired memory busy rate and the cache busy rate, the pre-swap starting unit 47 determines whether to allow the cache access execution unit 48 to execute a swap process.

If the pre-swap starting unit 47 determines to allow the cache access execution unit 48 to execute a swap process, the pre-swap starting unit 47 enters, into the cache access execution unit 48, a cache line address targeted for the swap process together with a pre swap command that indicates that the swap process is to be executed.

Specifically, the pre-swap starting unit 47 determines whether the state satisfies the pre swap condition in which the memory busy rate monitored by the memory busy rate monitoring unit 35 is lower than a first threshold and the cache busy rate monitored by the cache busy rate monitoring unit 46 is lower than a second threshold. If the pre-swap starting unit 47 determines that the memory busy rate is lower than the first threshold and the cache busy rate is lower than the second threshold, i.e., determines that the state satisfies the pre swap condition, the pre-swap starting unit 47 allows the cache access execution unit 48 to start the pre-swap process.

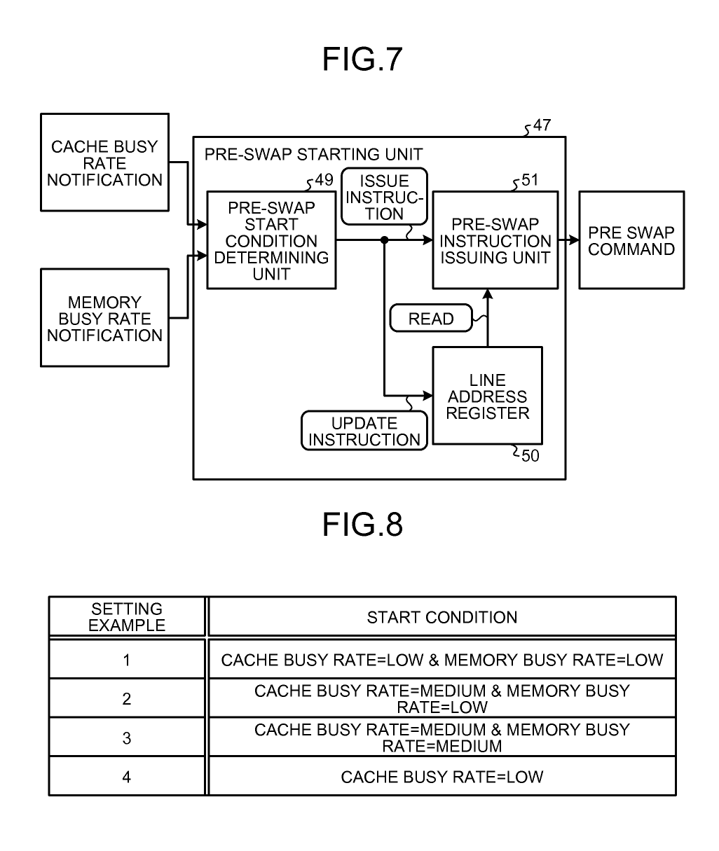

In the following, the pre-swap starting unit 47 will be described in detail. FIG. 7 is a schematic diagram illustrating the pre-swap starting unit. In the example illustrated in FIG. 7, the pre-swap starting unit 47 includes a pre-swap start condition determining unit 49, a line address register 50, and a pre-swap instruction issuing unit 51.

The pre-swap start condition determining unit 49 receives notifications indicating the cache busy rate and the memory busy rate. Then, the pre-swap start condition determining unit 49 determines whether both the acquired cache busy rate and the memory busy rate satisfy the start condition.

If the pre-swap start condition determining unit 49 determines that both the acquired cache busy rate and the memory busy rate satisfy the start condition for a pre swap, the pre-swap start condition determining unit 49 sends an instruction to issue a pre swap command to the pre-swap instruction issuing unit 51. Furthermore, if the pre-swap start condition determining unit 49 determines that both the acquired cache busy rate and the memory busy rate satisfy the start condition for a pre swap, the pre-swap start condition determining unit 49 sends an update instruction to the line address register 50.

In contrast, if the pre-swap start condition determining unit 49 determines that both the acquired cache busy rate and the memory busy rate does not satisfy the start condition for a pre swap, the pre-swap start condition determining unit 49 ends the process and waits to receive, as notifications, a new cache busy rate and a new memory busy rate.

FIG. 8 is a schematic diagram illustrating an example of the start condition for a pre-swap process. For example, the pre-swap start condition determining unit 49 stores therein, as setting example 1, the start condition for a pre swap in which the cache busy rate is “low” and the memory busy rate is “low”. Furthermore, the pre-swap start condition determining unit 49 stores therein, as setting example 2, the start condition for a pre swap in which the cache busy rate is “medium” and the memory busy rate is “low”.

Furthermore, the pre-swap start condition determining unit 49 stores therein, as setting example 3, the start condition for a pre swap in which the cache busy rate is “medium” and the memory busy rate is “medium”. Furthermore, the pre-swap start condition determining unit 49 stores therein, as setting example 4, the start condition for a pre swap in which the cache busy rate is “low”.

For example, if the setting example “1” is set as the start condition and if both the acquired cache busy rate and the memory busy rate are “low”, the pre-swap start condition determining unit 49 sends an instruction to issue an pre swap command to the pre-swap instruction issuing unit 51. Furthermore, for example, if the setting example “3” is set as the start condition and if both the acquired cache busy rate and the memory busy rate are “medium” or “low”, the pre-swap start condition determining unit 49 sends an instruction to issue a pre swap command.

The pre-swap start condition determining unit 49 can arbitrarily change the start condition for a pre swap that is set by using one of the example settings 1 to 4. Then, the pre-swap start condition determining unit 49 determines whether both the acquired cache busy rate and the memory busy rate satisfy the set start condition for the pre swap. The start conditions illustrated in FIG. 8 are only examples. Another start condition for a pre swap may also be set as long as a pre swap command can be entered at an appropriate time. Furthermore, the number of setting examples is not limited to that illustrated in FIG. 8.

The line address register 50 is a register that stores therein a cache line address targeted for the pre-swap process. Specifically, the line address register 50 stores therein “0” as the initial value of a value of a cache line address. Then, if the line address register 50 receives an update instruction from the pre-swap start condition determining unit 49, the line address register 50 increments the value of the cache line address.

Specifically, the line address register 50 adds 1 to a value of the stored cache line address every time the line address register 50 receives an update instruction. If the line address register 50 receives again another update instruction when the value of the stored cache line address reaches the maximum number of lines of the cache line addresses in the L2 data storing unit 42, the line address register 50 wraps around the value of the cache line address to “0”.

If the pre-swap instruction issuing unit 51 receives an issue instruction from the pre-swap start condition determining unit 49, the pre-swap instruction issuing unit 51 reads a cache line address stored in the line address register 50. Then, the pre-swap instruction issuing unit 51 creates a pre swap command that is an execution request for a swap process performed on data that is stored in the read cache line address. Then, the pre-swap instruction issuing unit 51 enters the created pre swap command into the cache access execution unit 48 when no command is entered from the command queue storing unit 43.

A description will be given here by referring back to FIG. 6. If a pre swap command is entered, the cache access execution unit 48 executes a swap process that stores, in the memory 12, the cache data stored in the L2 data storing unit 42 based on the tag data stored in the L2 tag storing unit 41.

In the following, a process performed by the cache access execution unit 48 will be described in detail. If a read command is entered from the command queue storing unit 43, the cache access execution unit 48 determines whether the cache data indicated by the read command is stored in the L2 data storing unit 42.

If it is determined that the cache data indicated by the read command is stored in the L2 data storing unit 42, the cache access execution unit 48 sends, to the L2 data storing unit 42, an instruction of a data response with respect to the L1 cache control unit 25. The instruction of the data response includes the same cache address as that of the entered read command.

In contrast, if it is determined that the cache data indicated by the read command is not stored in the L2 data storing unit 42, the cache access execution unit 48 issues, to the memory control unit 30, a memory access command indicating that the data stored in the memory 12 is to be read. Furthermore, the cache access execution unit 48 issues, to the L2 data storing unit 42, a read instruction indicating that a response data that is sent from the memory control unit 30 to the response data buffer 45.

Furthermore, if a pre swap command is entered from the pre-swap starting unit 47, the cache access execution unit 48 searches the L2 tag storing unit 41 for tag data stored in the cache line address that is indicated by the entered pre swap command.

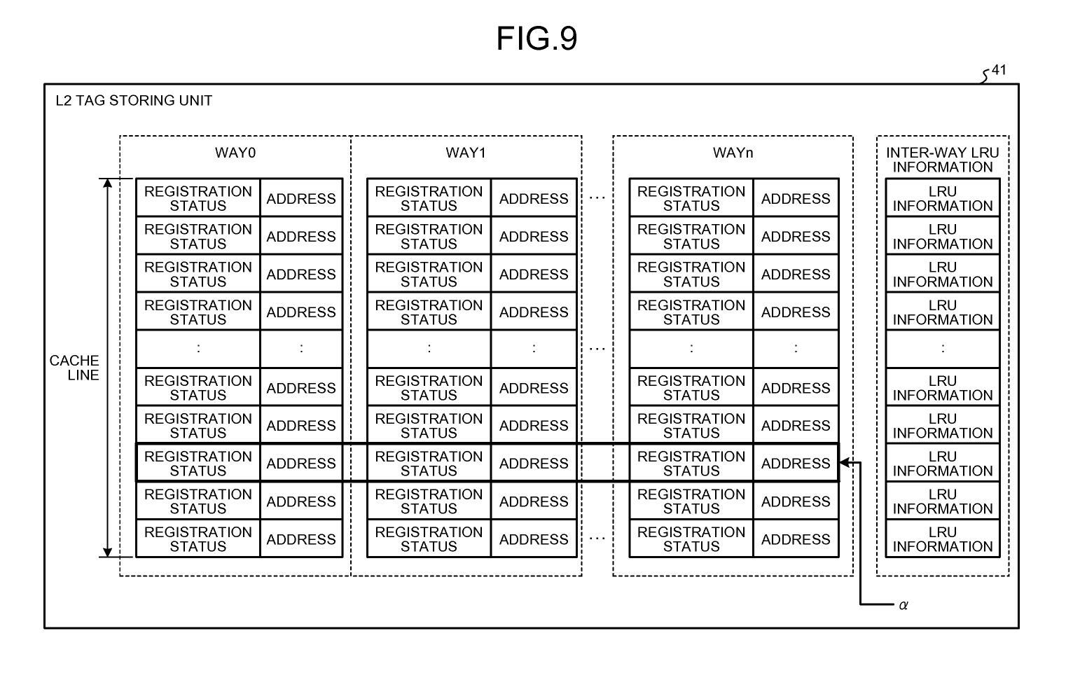

FIG. 9 is a schematic diagram illustrating a process for searching for an entry targeted for the pre-swap process. In the example illustrated in FIG. 9, it is assumed that the cache access execution unit 48 has acquired a pre swap command that indicates a cache line address that indicates the cache line represented by a illustrated in FIG. 9. Furthermore, in the example illustrated in FIG. 9, it is assumed that multiple entries are stored in multiple cache ways WAY 0 to WAY n in a single cache line.

The cache access execution unit 48 searches the tag data, which is included in the cache line represented by a illustrated in FIG. 9, for an entry that is cache data read from the memory 12 and whose registration status is “Modified”.

If an entry that is cache data read from the memory 12 and whose registration status is “Modified” is present, the cache access execution unit 48 selects an entry that satisfies the condition. Furthermore, if multiple entries that satisfy the condition are present, the cache access execution unit 48 selects an entry that has not been accessed for the longest time period from among the entries that satisfy the condition by using, similarly to the known WAY selection algorithm, inter-WAY least recently used (LRU) information.

Then, the cache access execution unit 48 updates “Modified”, which is the registration status of the selected entry, to “Exclusive”. Furthermore, the cache access execution unit 48 issues, to the memory control unit 30, a write command that instructs the cache data stored in the selected entry to be written in the memory 12 and then it sends a write instruction indicating the cache data stored in the selected entry to the L2 data storing unit 42.

Furthermore, if the cache access execution unit 48 determines that no entry whose registration status is “Modified” and that is the cache data read from the memory 12 is present, the cache access execution unit 48 suspends the pre-swap process.

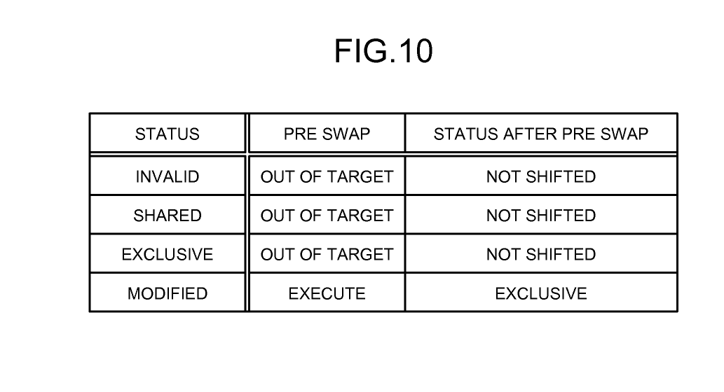

FIG. 10 is a schematic diagram illustrating the target for the pre-swap process. As described above, if the pre-swap starting unit 47 determines that both the cache busy rate and the memory busy rate is lower than the predetermined threshold, the cache access execution unit 48 starts the pre-swap process. Then, as illustrated in FIG. 10, the cache access execution unit 48 does not execute the pre-swap process on the data in the entry whose registration status is “Invalid”, “Shared”, or “Exclusive” and also does not shift the registration status that is indicated by the tag data.

However, the cache access execution unit 48 does perform the pre-swap process on the cache data in an entry whose registration status is “Modified” and then shifts the registration status to “Exclusive”. Specifically, the cache access execution unit 48 gives priority to the execution of the write back process such that the cache data in an entry whose registration status is “Modified” is updated in the memory 12. Consequently, the cache access execution unit 48 reduces the occurrence of a swap process that performs a write back process and reduces the busy rate of the memory 12, thus improving the performance of the data response from the memory 12.

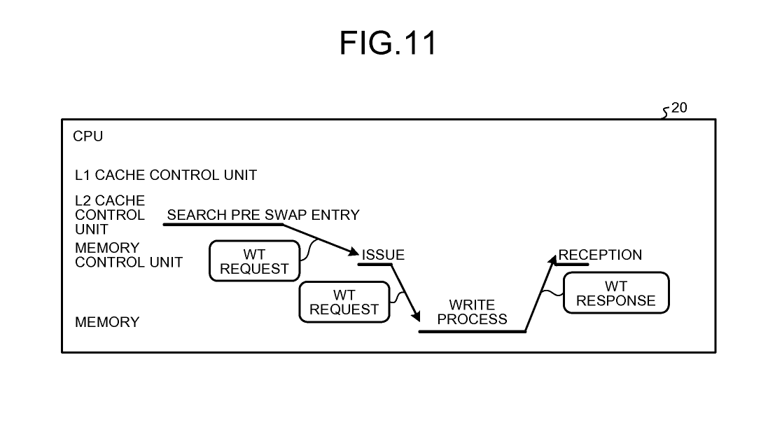

FIG. 11 is a schematic diagram illustrating the flow of the pre-swap process. In the example illustrated in FIG. 11, the L2 cache control unit 40 starts the pre-swap process if the memory busy rate is lower than the first threshold and if the cache busy rate is lower than the second threshold. First, the L2 cache control unit 40 searches for an entry targeted for the pre-swap process. If an entry targeted for the pre-swap process is present, the L2 cache control unit 40 issues, to the memory control unit 30, a write request for cache data, which is in an entry targeted for the pre-swap process, to be written in the memory 12.

If the memory control unit 30 acquires the write request from the L2 cache control unit 40, the memory control unit 30 issues, to the memory 12, a write request for cache data, which is in an entry for the pre-swap process, to be written. Then, the memory control unit 30 receives a response to the write request from the memory 12. Thereafter, the memory control unit 30 and the L2 cache control unit 40 ends the pre-swap process.

The instruction execution unit 24, the memory access execution unit 34, the memory busy rate monitoring unit 35, the cache busy rate monitoring unit 46, the pre-swap starting unit 47, the cache access execution unit 48, the pre-swap start condition determining unit 49, and the pre-swap instruction issuing unit 51 are, for example, control circuits included in the arithmetic processing unit. Examples of the arithmetic processing unit include a central processing unit (CPU), a micro processing unit (MPU), a graphics processing unit (GPU), a digital signal processor (DSP), and the like and also include a microcontroller that is implemented by an application specific integrated circuit (ASIC), a field programmable gate array (FPGA), and the like.

Furthermore, the L1 tag storing unit 26, the L1 data storing unit 27, the L2 tag storing unit 41, and the L2 data storing unit 42 are storage devices. Examples of the storage devices include a semiconductor memory device, such as a random access memory (RAM) or a read only memory (ROM). The command queue storing unit 31, the write data buffer 32, the response data buffer 33, the command queue storing unit 43, the write data buffer 44, and the response data buffer 45 are buffers that retains acquired data.

### [The Flow of the Pre-Swap Process]

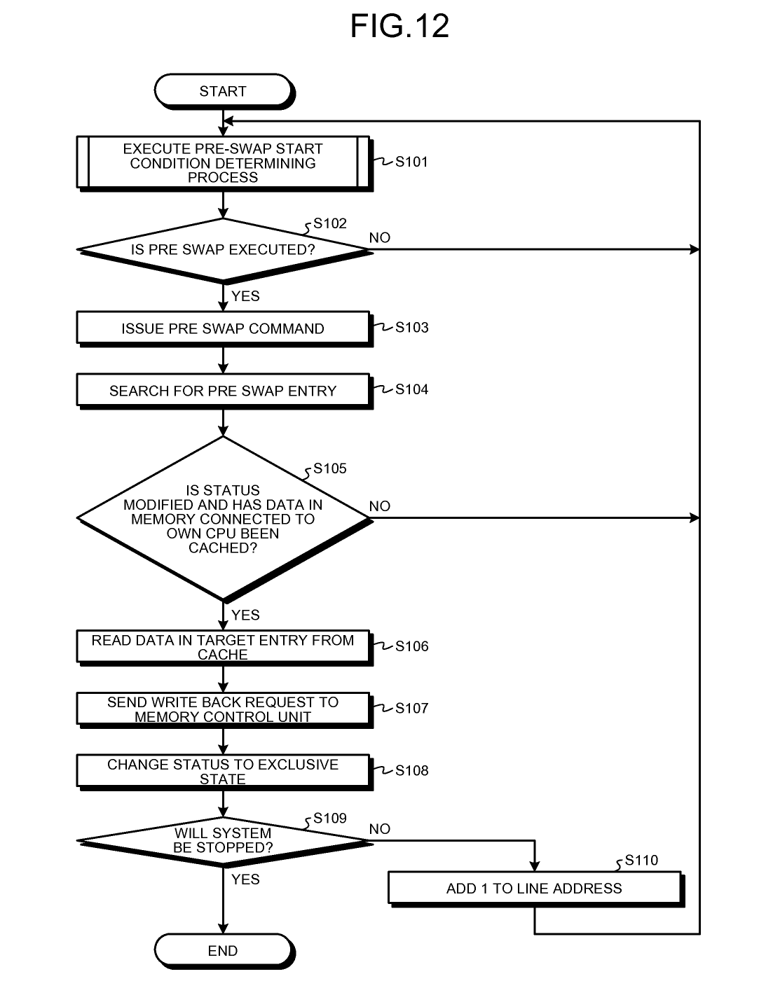

In the following, the flow of the pre-swap process performed by the L2 cache control unit 40 will be described with reference to FIG. 12. FIG. 12 is a flowchart illustrating the process for searching for an entry targeted for a pre-swap. In the example illustrated in FIG. 12, the L2 cache control unit 40 performs the process triggered when the power supply is turned on or a pre swap mode is set in the register.

First, the L2 cache control unit 40 executes the pre-swap start condition determining process, which will be described later (Step S101). Then, the L2 cache control unit 40 determines whether a pre swap is to be executed by using the pre-swap start condition determining process (Step S102).

If the L2 cache control unit 40 determines that a pre swap is to be executed (Yes at Step S102), the L2 cache control unit 40 issues a pre swap command (Step S103). Then, the L2 cache control unit 40 searches, by using tag data, the cache line indicated by the pre swap command for an entry that is targeted for the pre swap (Step S104).

At this point, the L2 cache control unit 40 determines whether the entry whose registration status of the tag data is “Modified” and in which data in the memory 12 connected to the corresponding CPU, i.e., the CPU 20, is registered (Step S105). Then, if it is determined that the entry whose registration status of the tag data is “Modified” and in which data in the memory 12 connected to the CPU 20 is registered (Yes at Step S105), the L2 cache control unit 40 reads the cache data in the entry (Step S106).

Then, the L2 cache control unit 40 issues a write back request for the read cache data to the memory control unit 30 (Step S107). Furthermore, the L2 cache control unit 40 changes the registration status of the target entry from “Modified” to “Exclusive” (Step S108). Then, the L2 cache control unit 40 determines whether the system will be stopped (Step S109). If it is determined that the system will be stopped (Yes at Step S109), the L2 cache control unit 40 ends the process.

In contrast, if it is determined that the system will not be stopped (No at Step S109), the L2 cache control unit 40 adds “1” to the cache line address stored in the line address register 50 (Step S110). Then, the L2 cache control unit 40 executes the pre-swap start condition determining process again (Step S101).

Furthermore, if it is determined that a pre swap is not executed, (No at Step S102), the L2 cache control unit 40 executes the pre-swap start condition determining process again (Step S101). Furthermore, if it is determined that the registration status is “Modified” and the data in the memory 12 is not cached (No at Step S105), the L2 cache control unit 40 executes the pre-swap start condition determining process again (Step S101).

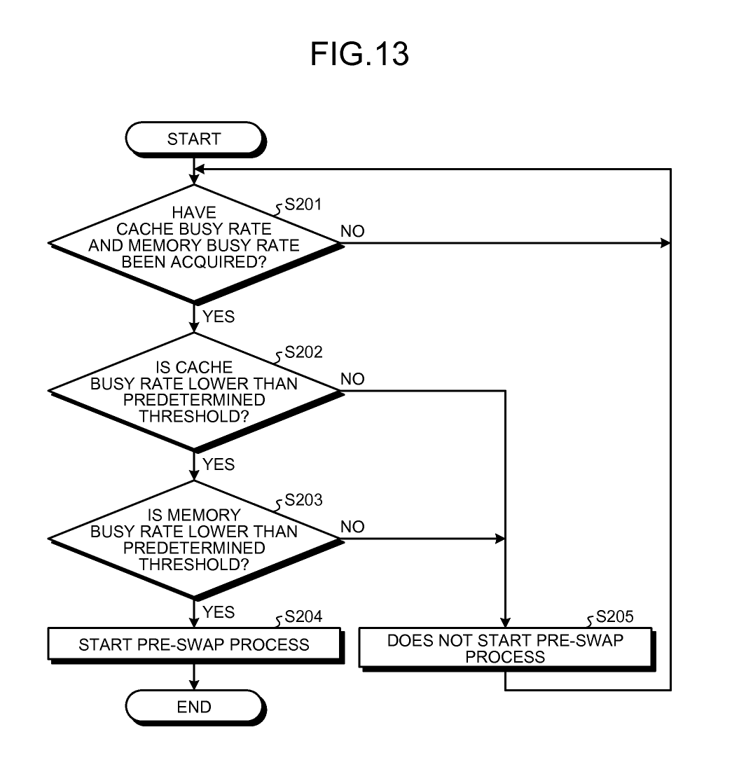

In the following, the flow of the pre-swap start condition determining process illustrated at Step S101 in FIG. 12 will be described in detail with reference to FIG. 13. FIG. 13 is a flowchart illustrating the flow of a pre-swap start condition determining process. The pre-swap start condition determining process is a process executed by the pre-swap starting unit 47 in the L2 cache control unit 40.

First, the pre-swap starting unit 47 determines whether the cache busy rate and the memory busy rate are acquired (Step S201). If it is determined that the cache busy rate and the memory busy rate are acquired (Yes at Step S201), the pre-swap starting unit 47 determines whether the cache busy rate is lower than the set predetermined threshold (Step S202). If it is determined that the cache busy rate is lower than the set predetermined threshold (Yes at Step S202), the pre-swap starting unit 47 further determines whether the memory busy rate is lower than the predetermined threshold (Step S203).

If it is determined that the memory busy rate is lower than the predetermined threshold (Yes at Step S203), the pre-swap starting unit 47 starts the pre-swap process (Step S204). Specifically, the L2 cache control unit 40 determines that the pre-swap process is to be executed.

In contrast, if it is determined that neither the cache busy rate nor the memory busy rate are acquired (No at Step S201), the pre-swap starting unit 47 waits until both the cache busy rate and the memory busy rate are acquired.

Furthermore, if it is determined that the busy rate of the cache memory is higher than the set predetermined threshold (No at Step S202), the pre-swap starting unit 47 does not start the pre-swap process (Step S205). Furthermore, if it is determined that the memory busy rate is higher than the predetermined threshold (No at Step S203), the pre-swap starting unit 47 does not start the pre-swap process (Step S205). Specifically, the L2 cache control unit 40 determines that pre-swap process is not to be executed. Then, the pre-swap starting unit 47 determines whether a new cache busy rate and a memory busy rate are acquired (Step S201).

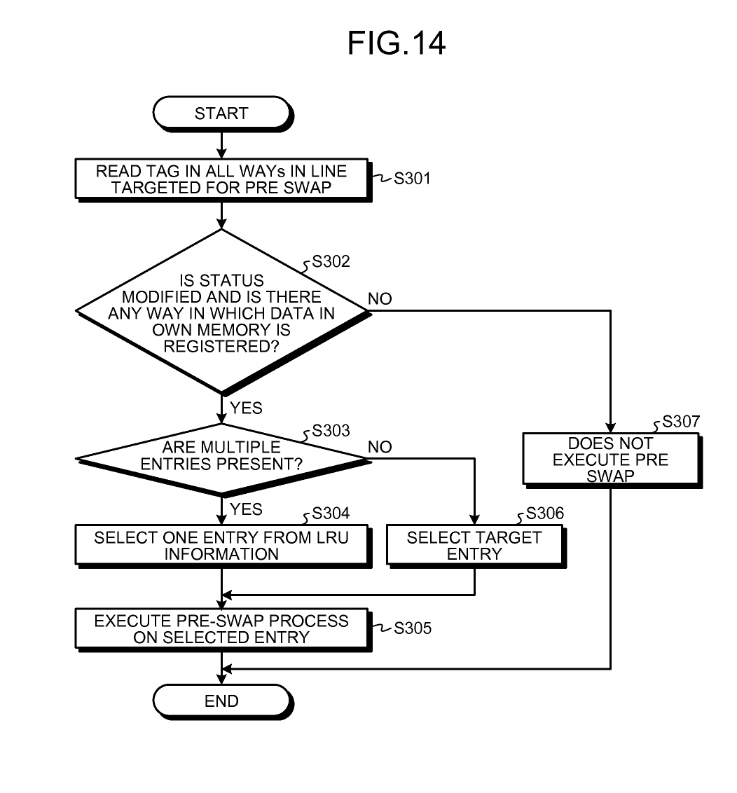

In the following, a process for searching an entry targeted for the pre swap illustrated at Step S104 in FIG. 12 will be described in detail with reference to FIG. 14. FIG. 14 is a flowchart illustrating, in detail, the flow of a process for searching for an entry. Steps S301 to S307 illustrated in FIG. 14 corresponds to Steps S104 to S105 illustrated in FIG. 12.

If the L2 cache control unit 40 issues a pre swap command (Step S103 in FIG. 12), the L2 cache control unit 40 reads tag data in all of the WAYs included in the cache line addresses indicated by the pre swap (Step S301). Then, the L2 cache control unit 40 determines whether, from the read tag data, there is a WAY whose registration status is “Modified” and in which data in a memory that is connected to the corresponding CPU is registered (Step S302, corresponding to Step S105 in FIG. 12).

If there is a WAY whose registration status is “Modified” and in which data in the memory 12 is registered (Step S302), the L2 cache control unit 40 determines whether multiple entries that satisfy this condition are present (Step S303). If it is determined that multiple entries that satisfy this condition are present (Yes at Step S303), the L2 cache control unit 40 selects the entry that hasn't been used for the longest period of time by using the LRU information (Step S304).

Then, the L2 cache control unit 40 executes the pre-swap process on the selected entry as the target for the pre-swap process (Step S305). Furthermore, if only one entry that satisfies the condition is present (No at Step S303), the L2 cache control unit 40 selects this entry (Step S306). Then, the L2 cache control unit 40 executes the pre-swap process on the selected entry as the target for the pre-swap process (Step S305).

In contrast, if there is no WAY whose registration status is “Modified” and in which data in the memory 12 connected to the CPU 20 is cached (No at Step S302), the L2 cache control unit 40 does not execute the swap process (Step S307), and ends the process.

[Advantage of the First Embodiment]

As described above, the CPU 20 includes the memory busy rate monitoring unit 35 that monitors the frequency of access to the memory 12, i.e., monitors the memory busy rate and also includes the cache busy rate monitoring unit 46 that monitors the frequency of access to the L2 data storing unit 42, i.e., monitors the cache busy rate. Furthermore, the CPU 20 executes the pre-swap process based on the monitored memory busy rate and the cache busy rate.

Consequently, the CPU 20 can give priority to the execution of a swap process on a cache memory when the number of accesses to the memory 12, which is the main memory of the CPU 20, is small and complete the write back process on the memory 12. Because of this, even if a process for continuously caching new data from the memory 12 occurs, the CPU 20 does not need to execute the write back process. Consequently, a delay with respect to a read request can be reduced, and thus it is possible to improve the performance of a data response with respect to the instruction execution unit 24, i.e., a processor core.

Furthermore, because the CPU 20 includes the memory control unit 30 that accesses the memory, the CPU 20 can directly monitor the memory busy rate. Furthermore, because the CPU 20 includes the L2 cache control unit 40 that includes a cache memory, the CPU 20 can directly monitor the cache busy rate. Consequently, the CPU 20 can execute the pre-swap process at an appropriate time in accordance with the current memory busy rate and the estimated future memory busy rate.

Furthermore, if the memory busy rate is lower than the set predetermined threshold and if the cache busy rate is lower than the set predetermined threshold, the CPU 20 starts the pre-swap process. Consequently, the CPU 20 can execute the pre-swap process at an appropriate time.

Specifically, the CPU 20 estimates the future memory busy rate by using the cache busy rate. If it is determined that the current memory busy rate is lower than the predetermined threshold and the future memory busy rate is lower than the predetermined threshold, the CPU 20 executes the current pre-swap process. Therefore, the CPU 20 can execute the pre-swap process when the number of accesses to the memory 12 is small. Consequently, the CPU 20 can execute the pre-swap process at an appropriate time without degrading the performance of the data response to a normal memory access.

Furthermore, the CPU 20 searches the pieces of tag data in cache lines for an entry whose registration status is “Modified” and then uses the cache data in the entry whose registration status is “Modified” as the target for the pre-swap process. Consequently, because the CPU 20 only uses the cache data in the entry that needs to be subjected to the write back process as the target for the pre swap process, the CPU 20 can efficiently execute the pre-swap process.

Furthermore, the CPU 20 changes the registration status included in the tag data in the entry targeted for the pre-swap process from “Modified” to “Exclusive”. Consequently, the CPU 20 can appropriately and continuously use the cache data targeted for the pre-swap process without executing a process for writing or deleting the cache data.

Furthermore, the CPU 20 calculates the memory busy rate in accordance with the number of commands retained in the command queue storing unit 31 in the memory control unit 30. Consequently, the CPU 20 can easily and appropriately calculate the memory busy rate.

Furthermore, the CPU 20 calculates the cache busy rate in accordance with the number of commands retained in the command queue storing unit 43. Consequently, the CPU 20 can easily and appropriately calculate the cache busy rate.

### [b] Second Embodiment

In the above explanation, a description has been given of the embodiment according to the present invention; however, the embodiment is not limited thereto and can be implemented with various kinds of embodiments other than the embodiment described above. Therefore, another embodiment will be described as a second embodiment below.

(1) Target for the Pre-Swap Process

In the first embodiment, the L2 cache control unit 40 executes the pre-swap process on the cache data that has been cached from the memory 12. However, the L2 cache control unit 40 may also execute a pre swap on the cache data that has been cached from the memories 13 to 15 connected to the other CPUs 21 to 23, respectively. Specifically, a symmetric multiprocessing (SMP) system, in which the memory 12 is shared with the other CPUs 21 to 23 and the like via the inter-LSI communication control unit 28, may also be used for the L2 cache control unit 40.

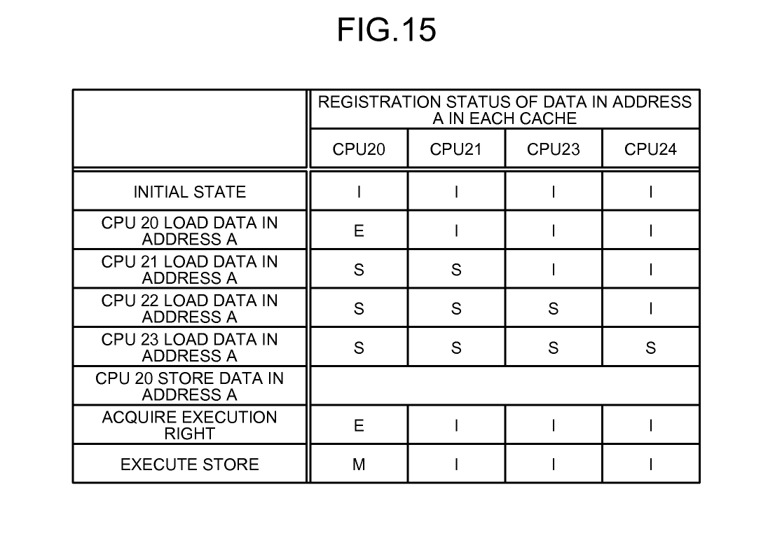

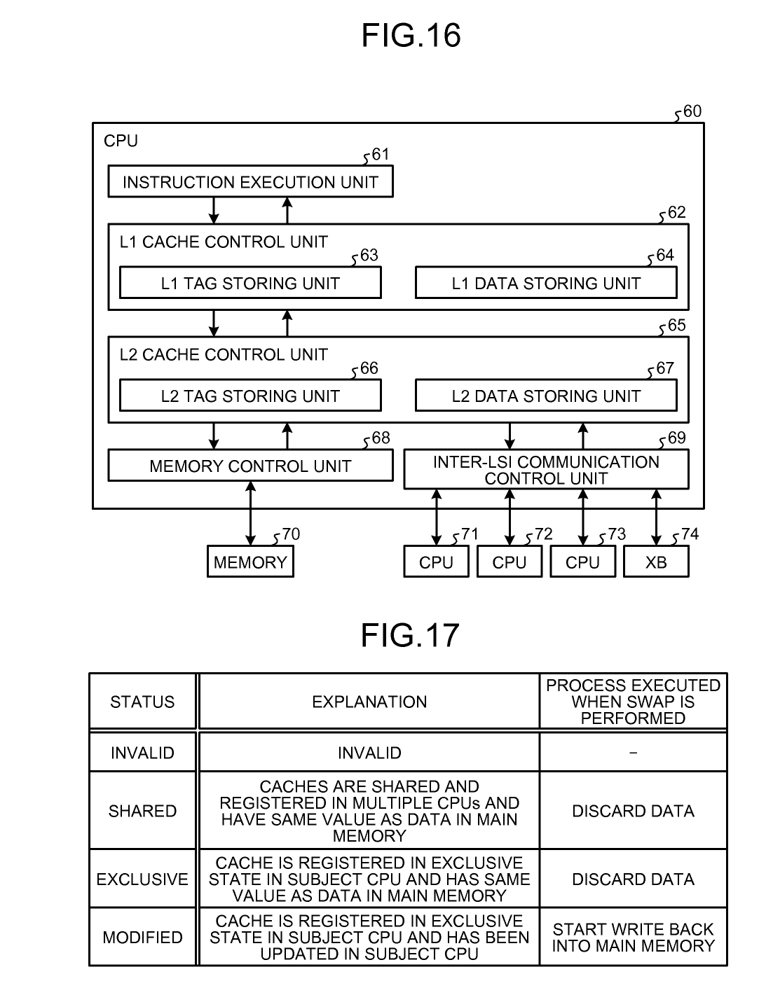

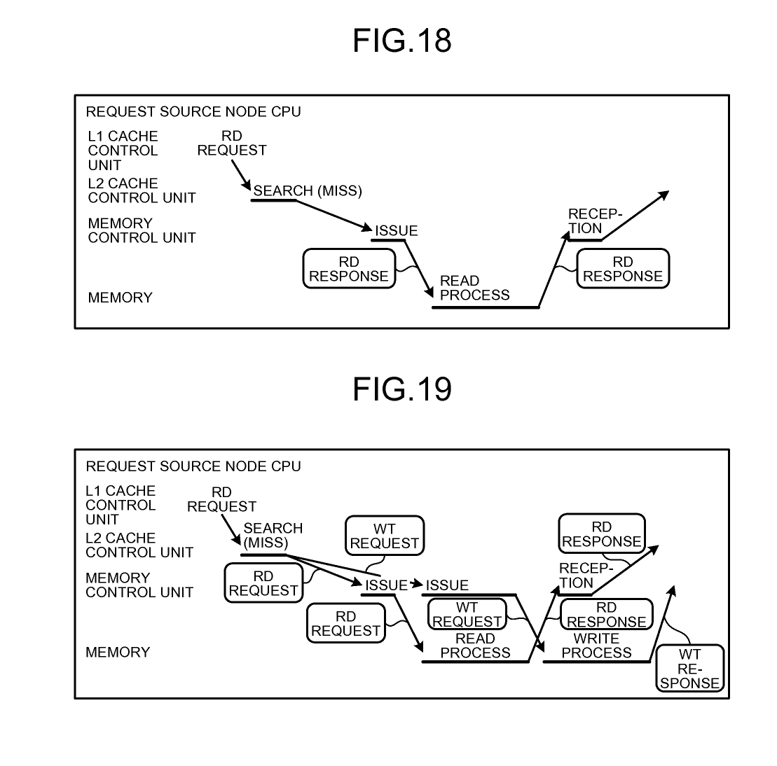

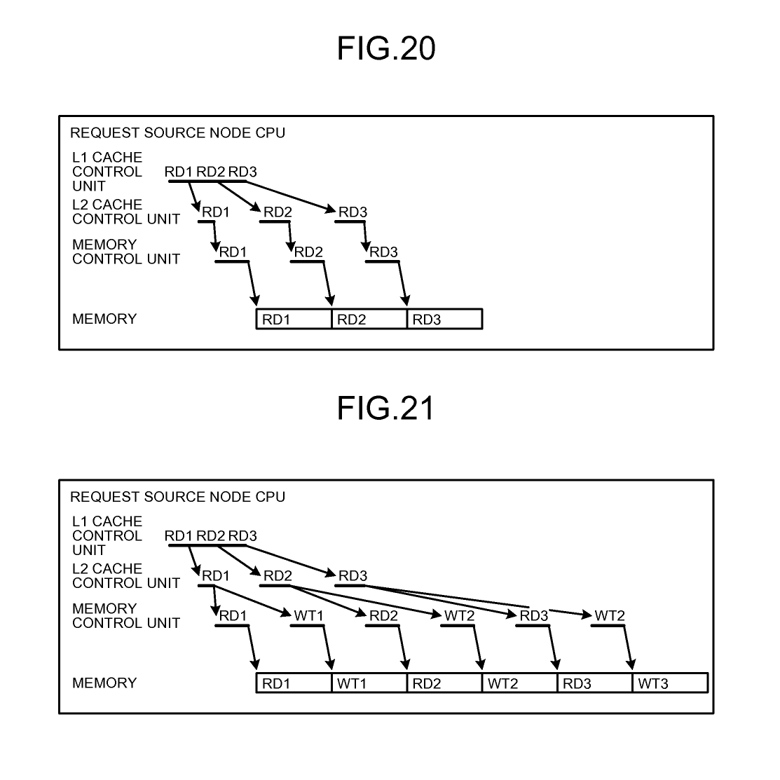

FIG. 15 is a flowchart illustrating an example of the shift of the state of a cache included in each CPU that is used in an SMP system. The symbol “I” illustrated in FIG. 15 represents “Invalid”, the symbol “E” represents “Exclusive”, the symbol “S” represents “Shared”, and “M” represents “Modified”. In the description below, from among pieces of data stored in the memories 12 to 15, the data stored in the address “A” is shared with the CPUs 20 to 23.

The initial state of the registration status of each entry in which data is registered by each of the CPUs 20 to 23 is “Invalid”. At this point, if the CPU 20 loads the data stored in the address “A”, the registration status of the entry in which the data loaded by the CPU 20 is registered shifts to “Exclusive”.

Thereafter, if the CPU 21 loads the data stored in the address “A”, the registration status of the entry in which the data loaded by the CPU 21 is to be registered shifts to “Shared”. Furthermore, the registration status of the entry in which the data loaded by the CPU 20 is to be registered shifts to “Shared”. Then, if the CPU 22 loads the data stored in the address “A”, the registration status of the entry in which the data loaded by the CPU 22 is to be registered shifts to “Shared”. Similarly, if the CPU 23 loads the data stored in the address “A”, the registration status of the entry in which the data loaded by the CPU 23 is to be registered shifts to “Shared”.

At this point, if the CPU 20 stores the loaded data, the CPU 20 acquires an execution right in order to retain coherence. Then, as illustrated in FIG. 15, the registration status of the entry in which the data in the address “A” is registered by the CPU 20 shifts to “Exclusive” and the registration status of each of the entries in which the data in the address “A” registered by each of the CPUs 21 to 23 shifts to “Invalid”.

Thereafter, the CPU 20 stores the loaded data. Then, because the identity between the cache data in the address “A” retained by the CPU 20 and the data in the address “A” in the memory is destroyed, the registration status of the entry in which data in the address “A” has been registered by the CPU 20 shifts to “Modified”.

Even if a CPU used in an SMP system is used, by executing the pre-swap process described above, it is possible to give priority to the execution of the write back process on the cache data whose registration status is “Modified”.

For example, each of the CPUs 20 to 23 sends the memory busy rate of its own CPU to the other CPUs 20 to 23 other than the CPU that is the sending source. If each of the CPUs 20 to 23 performs the pre-swap process, each of the CPUs 20 to 23 selects, from among the memory busy rates received from the CPUs, the CPU that sends the busy rate lower than the predetermined threshold. Then, the CPUs 20 to 23 may also use the cache data acquired from the memory that is connected to the selected CPU as the target for the pre swap.

Furthermore, each of the CPUs 20 to 23 sends the cache busy rate of its own CPU to the other CPUs 20 to 23 other than the CPU that is the sending source. From among the cache busy rates received from the CPUs, each of the CPUs 20 to 23 uses the cache data acquired from the memory connected to the CPU that sends the cache busy rate lower than a predetermined threshold as the target for the pre swap. Furthermore, each of the CPUs 20 to 23 may also select cache data targeted for the pre swap based on the cache busy rate and the memory busy rate received from each of the CPUs as a notification.

(2) Threshold

The memory busy rate monitoring unit 35 and the cache busy rate monitoring unit 46 described above determine the memory busy rate and the cache busy rate by using the same threshold; however, the embodiment is not limited thereto. For example, the memory busy rate monitoring unit 35 and the cache busy rate monitoring unit 46 may also determine the memory busy rate and the cache busy rate by using different thresholds.

Furthermore, as illustrated in FIG. 8, the pre-swap starting unit 47 described above includes multiple settings that can be arbitrarily changed; however, the embodiment is not limited thereto. For example, the pre-swap starting unit 47 may also include only a single start condition indicating whether the pre-swap process is to be executed.

Furthermore, in the first embodiment, “low”, “medium”, and “high” are used as the values indicating the memory busy rate and the cache busy rate; however, the embodiment is not limited thereto. A value, such as the number of counted commands, may also be used. Furthermore, the number of commands stored in the command queue storing unit 31 and the command queue storing unit 43 may also be used for the memory busy rate and the cache busy rate.

Furthermore, in the first embodiment, the time at which the pre-swap process is executed is determined by using both the memory busy rate and the cache busy rate; however, the embodiment is not limited thereto. For example, the time at which the pre-swap process is executed may also be determined by using only one of the memory busy rate and the cache busy rate.

(3) Hierarchy of a Cache

In the first embodiment, the CPU 20 executes the pre-swap process at a time based on the cache busy rate of the L2 data storing unit 42 in the L2 cache control unit 40; however, the embodiment is not limited thereto. For example, the pre-swap process may also be executed at a time that takes into consideration the cache busy rate of an L1 cache or an L3 cache.

(4) Registration Status

The L2 tag storing unit 41 described above stores therein the registration status by using the MESI protocol (Illinois protocol); however, the embodiment is not limited thereto. An arbitrary protocol may also be used to indicate the status of cache data as long as a CPU that executes the write back process that writes cache data into the main memory is used.

According to an aspect of the present invention, the performance of a data response is improved.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor that is connected to a main storage device, the processor comprising:
a cache memory unit that includes a plurality of cache lines each of which retains data;
a tag memory unit that includes a plurality of tags each of which is associated with one of the cache lines and retains state information on data retained in an associated cache line;
a main storage control unit that accesses the main storage device;
a cache control unit that accesses the cache memory unit;
a main storage access monitoring unit that monitors a first access frequency that indicates the frequency of access to the main storage device from the main storage control unit;
a cache access monitoring unit that monitors a second access frequency that indicates the frequency of access to the cache memory unit from the cache control unit; and
a swap control unit that allows the cache control unit to retain data, which is retained in a cache line included in the cache memory unit, in the main storage device based on the first access frequency monitored by the main storage access monitoring unit, the second access frequency monitored by the cache access monitoring unit, and the state information retained in a tag.

2. The processor according to claim 1, wherein
when the first access frequency monitored by the main storage access monitoring unit is lower than a first threshold and the second access frequency monitored by the cache access monitoring unit is lower than a second threshold, the swap control unit allows the cache control unit to start searching the tag memory unit, and
when state information, which indicates that data that is associated with the state information is retained in only the cache memory unit and has been updated by the processor, has been searched for in the tag memory unit, the swap control unit allows the cache control unit to retain, in the main storage device, the data associated with the searched state information.

3. The processor according to claim 2, wherein
after the cache control unit starts searching the tag memory unit, when state information, which indicates that the data that is associated with the state information is retained in only the cache memory unit and has been updated by the processor, has been searched for in the tag memory unit, the swap control unit further allows the cache control unit to retain data associated with the searched state information in the main storage device and allows the cache control unit to change the searched state information to state information indicating that the data associated with the searched state information is retained in only the cache memory unit and is identical to associated data that is stored in an address in the main storage device.

4. The processor according to claim 1, further comprising a main storage access command retaining unit that includes a plurality of first entries each of which retains a command to access the main storage device, wherein the main storage access monitoring unit monitors the first access frequency based on the number of commands retained in the first entries in the main storage access command retaining unit.

5. The processor according to claim 1 further comprising a cache access command retaining unit that includes a plurality of second entries each of which retains a command to access the cache memory unit, wherein the cache access monitoring unit monitors the second access frequency to the cache memory unit from the cache control unit based on the number of commands retained in the second entries in the cache access command retaining unit.

6. An information processing device comprising:
a main storage device; and
a processor that is connected to the main storage device, wherein
the processor includes
a cache memory unit that includes a plurality of cache lines each of which retains data,
a tag memory unit that includes a plurality of tags each of which is associated with one of the cache lines and retains state information on data retained in an associated cache line,
a main storage control unit that accesses the main storage device,
a cache control unit that accesses the cache memory unit,
a main storage access monitoring unit that monitors a first access frequency that indicates the frequency of access to the main storage device from the main storage control unit,
a cache access monitoring unit that monitors a second access frequency that indicates the frequency of access to the cache memory unit from the cache control unit, and
a swap control unit that allows the cache control unit to retain data, which is retained in a cache line, in the main storage device based on the first access frequency monitored by the main storage access monitoring unit, the second access frequency monitored by the cache access monitoring unit, and the state information retained in a tag.

7. The information processing device according to claim 6, wherein
when the first access frequency monitored by the main storage access monitoring unit is lower than a first threshold and the second access frequency monitored by the cache access monitoring unit is lower than a second threshold, the swap control unit allows the cache control unit to start searching the tag memory unit, and
when state information, which indicates that data that is associated with the state information is retained in only the cache memory unit and has been updated by the processor, has been searched from the tag memory unit, the swap control unit allows the cache control unit to retain, in the main storage device, the data associated with the searched state information.

8. The information processing device according to claim 7, wherein
after the cache control unit starts searching the tag memory unit, when state information, which indicates that the data that is associated with the state information is retained in only the cache memory unit has been updated by the processor, has been searched for in the tag memory unit, the swap control unit further allows the cache control unit to retain data associated with the searched state information in the main storage device and allows the cache control unit to change the searched state information to state information indicating that the data associated with the searched state information is retained in only the cache memory unit and is identical to associated data that is stored in an address in the main storage device.

9. The information processing device according to claim 6, wherein
the processor further includes a main storage access command retaining unit that includes a plurality of first entries each of which retains a command to access the main storage device, and
the main storage access monitoring unit monitors the first access frequency based on the number of commands retained in the first entries in the main storage access command retaining unit.

10. The information processing device according to claim 6, wherein
the processor further includes a cache access command retaining unit that includes a plurality of second entries each of which retains a command to access the cache memory unit, and
the cache access monitoring unit monitors the second access frequency to the cache memory unit from the cache control unit based on the number of commands retained in the second entries in the cache access command retaining unit.

11. A control method for a processor that is connected to a main storage device, the control method comprising:
monitoring, performed by a main storage access monitoring unit in the processor, a first access frequency that is the frequency of access to the main storage device from a main storage control unit;
monitoring, performed by a cache access monitoring unit in the processor, a second access frequency that is the frequency of access from a cache control unit to a cache memory unit that includes a plurality of cache lines each of which retains data; and
retaining, performed by the cache control unit under the control of a swap control unit in the processor, data, which is retained in a cache line included in the cache memory unit, in the main storage device based on the first access frequency monitored by the main storage access monitoring unit, the second access frequency monitored by the cache access monitoring unit, and state information retained in a tag in a tag memory unit that includes a plurality of tags each of which retains the state information on data associated with a cache line.
